(19) United States
(12) Patent Application Publication
(10) Pub. No.: US 2014/0214134 A1
(43) Pub. Date: Jul. 31, 2014

(54) Closed Loop Chronic Electroacupuncture System Using Changes in Body Temperature or Impedance

(71) Applicant: Valencia Technologies Corporation, (US)

(72) Inventor: David K. L. Peterson, Valencia, CA (US)

(73) Assignee: VALENCIA TECHNOLOGIES CORPORATION, Valencia, CA (US)

(21) Appl. No.: 13/779,155

(22) Filed: Feb. 27, 2013

Related U.S. Application Data
(60) Provisional application No. 61/609,760, filed on Mar. 12, 2012.

(51) Int. Cl. A61H 39/00

(52) U.S. Cl. CPC A61H 39/002
USPC 607/62

(57) ABSTRACT

A closed loop electroacupuncture (EA) system monitors any change in sympathetic drive within the body of a patient undergoing EA stimulation. The sensed change in sympathetic drive is then used to adjust at least one parameter of the EA stimulation regimen in an appropriate manner that assists regulation of the patient's autonomic nervous system (ANS). One manner of determining an increase in sympathetic drive is to monitor the body temperature at the skin. A decrease in skin temperature is indicative of increased sympathetic drive and/or exercise stress due to vasoconstriction in the subcutaneous vascular bed. An adjunct to monitoring skin temperature is to monitor subcutaneous tissue impedance. Subcutaneous tissue impedance increases during vasoconstriction. Thus, a sensed change in tissue impedance may be used by itself, or as a compliment to sensed changes in temperature, to provide feedback within the closed loop EA system to adjust the stimulation regimen.

### RELATED APPLICATIONS

This application claims the benefit of the following previously-filed provisional patent applications: U.S. Provisional Patent Application No. 61/609,760, filed Mar. 12, 2012; and U.S. Provisional Patent Application No. 61/606,995, filed Mar. 6, 2012, which applications are incorporated herein by reference.

### BACKGROUND

The present disclosure describes a coin-sized and -shaped electroacupuncture (EA) stimulator of the type described in U.S. patent application Ser. No. 13/598,582, filed Aug. 29, 2012, which application is incorporated herein by reference, or equivalent small self-contained stimulators adapted for implantation under the skin. More particularly, the present disclosure relates to a method of using an implantable closed loop chronic EA stimulator where the stimulation intensity, frequency and/or duty cycle of the applied stimuli is adjusted, as required, based on sensed changes that occur in body or skin temperature and/or tissue impedance. This adjustment is made to maintain appropriate regulation of the patient's autonomic nervous system (ANS).

In accordance with the teachings of the application referenced above in paragraph [0002], a tiny, self-contained, coin-sized stimulator may be implanted in a patient at or near a specified acupoint(s) in order to favorably treat a condition or disease of a patient. The coin-sized stimulator advantageously applies electrical stimulation pulses at very low levels and duty cycles in accordance with specified stimulation regimens through electrodes that form an integral part of the housing of the stimulator. A coin-cell battery inside of the coin-sized stimulator provides enough energy for the stimulator to carry out its specified stimulation regimen over a period of several months or years. Thus, the coin-sized stimulator, once implanted, provides an unobtrusive, needleless, long-lasting, elegant and effective mechanism for treating certain conditions and diseases that have long been treated by acupuncture or electroacupuncture.

It is noted that electroacupuncture, or EA, has long been used by certain acupuncturists as an alternative to classical acupuncture. In classical acupuncture treatment, needles are inserted into the patient's body at specified acupoints located throughout the human body. The location of the acupoints on the human body is well documented, see, e.g., WHO STANDARD ACUPUNCTURE POINT LOCATIONS IN THE WESTERN PACIFIC REGION, published by the World Health Organization (WHO), Western Pacific Region, 2008 (updated and reprinted 2009), ISBN 978 92 9061 248 7 (hereafter “WHO Standard Acupuncture Point Locations 2008”). The Table of Contents, Forward (page v-vi) and General Guidelines for Acupuncture Point Locations (pages 1-21) of the WHO Standard Acupuncture Point Locations 2008 are incorporated herein by reference. The location of the acupoints as shown, e.g., in WHO Standard Acupuncture Point Locations 2008, has been determined based on over 2500 years of practical experience.

Despite the well-documented location of acupoints, it is noted that references to these acupoints in the literature has not always being consistent with respect to the format of the letter/number/name combination used to identify a particular acupoint. For example, some acupoints are identified by a name only, e.g., Tongi. The same acupoint may be identified by others by the name followed with a letter/number combination placed in parenthesis, e.g., Tongi (HT5). Other citations place the letter/number combination first, followed by the name, e.g., HT5 (Tongi). The first letter typically refers to a body organ, or other tissue location associated with, or affected by, that acupoint. However, usually only the letter is used in referring to the acupoint, but not always. Thus, for example, the acupoint P-6 is the same as acupoint Pericardium 6, which is the same as PC-6, which is the same as Pe 6, which is the same as P6 (Neiguan), which is the same as Neiguan. For purposes of this patent application, unless specifically stated otherwise, all references to acupoints that use the same name, or the same first letter and the same number, and regardless of slight differences in second letters and formatting, are intended to refer to the same acupoint. Thus, for example, the acupoint Neiguan is the same acupoint as Neiguan (P6), which is the same acupoint as Neiguan (PC6), which is the same acupoint as Neiguan (PC-6), which is the same acupoint as Neiguan (Pe-6), which is the same acupoint as P6, or P 6, or PC-6 or Pe 6.

In classical acupuncture treatment, once needles are inserted at a desired acupoint location(s), the needles are then mechanically modulated for a short treatment time, e.g., 30 minutes or less. The needles are then removed until the patient's next visit to the acupuncturist, e.g., in 1-4 weeks or longer, when the process is repeated. Over several visits, the patient's condition or disease is effectively treated, offering the patient needed relief and improved health.

In electroacupuncture treatment, needles are inserted at specified acupoints, as in classical acupuncture treatment, but the needles, once inserted, are then connected to a source of electrical radio frequency (RF) energy, and electrical stimulation signals, at a specified frequency and intensity level, are then applied to the patient's body through the needles at the acupoint(s), thereby also providing the patient with a measure of needed and desired treatment for his or her condition or disease.

As taught by Western medical theory, the organs (or the “viscera”) of the human body, such as the heart, stomach and intestines, are regulated by a part of the nervous system called the autonomic nervous system (ANS). The ANS is part of the peripheral nervous system and it controls many organs and muscles within the body. In most situations, a patient is unaware of the workings of the ANS because it functions in an involuntary, reflexive manner. For example, a person does not notice when blood vessels change size or when the heart beats faster. While a few people can be trained to control some functions of the ANS, such as heart rate or blood pressure, most people cannot do so effectively.

The ANS is most important in two situations: (1) in emergencies that cause stress and require a person to “fight” or take “flight” (run away); and (2) in nonemergencies that allow a person to “rest” and “digest.”

In general, the ANS regulates muscles and glands. The muscles it regulates comprise in large part smooth muscle in the skin (around hair follicles), around blood vessels, in the eye (the iris) and in the stomach, intestines and bladder. The ANS also regulates cardiac muscle of the heart.

The ANS is made up of two main parts: (1) the sympathetic nervous system, and (2) the parasympathetic nervous system. (A third component of the ANS is the enteric nervous system, but that is not relevant for purposes here.) The sympathetic nervous system regulates body organs that aid a person in “fight” or “flight” situations. For example, if a person suddenly encounters a life-threatening situation, the sympathetic nervous system is called into action, and it uses energy in a way that causes blood pressure to increase, heart rate to increase, and digestion to slow down.

In contrast, the parasympathetic nervous system regulates body organs that aid a person in “rest and digest” situations. For example, if a person is in a position where it is appropriate to relax, rest or sleep, then the parasympathetic nervous system begins to work to save energy, i.e., to reduce blood pressure, to slow the heart rate, and to allow digestion to start.

A summary of some of the effects of sympathetic and parasympathetic stimulation is shown in Table 1. The effects shown in Table 1 are generally in opposition to each other.

TABLE 1
Autonomic Nervous System

| Structure | Sympathetic Stimulation | Parasympathetic Stimulation |
|---|---|---|
| Iris (eye | Pupil Dilation | Pupil Constriction |
| muscle) | | |
| Salivary | Saliva production reduced | Saliva production increased |
| Glands | | |
| Oral/Nasal | Mucus production reduced | Mucus production increased |
| Mucosa | | |
| Heart | Heart rate and force | Heart rate and force |
| | increased | decreased |
| Lung | Bronchial muscle relaxed | Bronchial muscle contracted |
| Stomach | Peristalsis reduced | Gastric juice secreted; |
| | | motility increased |
| Small | Motility reduced | Digestion increased |
| intestine | | |
| Large | Motility reduced | Secretions and motility |
| intestine | | increased |
| Liver | Increased conversion of | |
| | glycogen to glucose | |
| Kidney | Decreased urine secretion | Increased urine secretion |
| Adrenal | Norepinephrine and | |
| medulla | epinephrine secreted | |
| Bladder | Wall relaxed, sphincter | Wall contracted, sphinchter |
| | closed | relaxed |

Another important aspect of the autonomic nervous system (ANS) is that it is always working. It is not only active during “fight” or “flight” situations, or “rest and digest” situations, but is also active at all times to maintain normal internal functions and to work with the somatic nervous system. (The preceding paragraphs, Paragraphs [0008] through [0013], describing the ANS are based, in large part, on material found on-line at http://faculty.washington.edu/chudler/auto.html.)

Open loop chronic electroacupuncture (EA), of the type used in the related applications referenced above in Paragraph [0001], does not respond to changes in demand for sympathetic inhibition. For example, changes in sympathetic drive or other environmental conditions that could increase or decrease the need for sympathetic inhibition are not incorporated into the operation of the open-loop EA stimulation device. (Such sympathetic inhibitions, or other actions associated with operation of a healthy ANS, may still be present, to one degree or another, in a patient due to the normal operation of the patient's ANS; but the open-loop EA system does not deliberately promote ANS activity—although it may unintentionally interfere with the patient's normal ANS activity.)

Thus, it is seen that there is a need, when EA stimulation is used to treat a condition or disease of the patient, to integrate the operation of the EA stimulation regimen with the normal operation of the patient's ANS in such a way that the EA stimulation does not adversely affect the overall operation of the ANS. The innovations described herein address that need.

### SUMMARY

As indicated above, open loop chronic electro-acupuncture (EA) stimulation, of the type described in the application referenced above in Paragraph [0002], does not necessarily respond to changes in demand for sympathetic inhibition. Changes in sympathetic drive, or other environmental conditions, could increase or decrease the need for sympathetic inhibition. Thus, in accordance with the teachings herein, any change in sympathetic drive within the body of a patient undergoing EA stimulation is monitored with an appropriate sensor(s), and this sensed change in sympathetic drive is then used by the EA device to adjust at least one parameter of the EA stimulation in an appropriate manner.

For example, one manner of determining an increase in sympathetic drive is to monitor the body temperature at the skin. A decrease in skin temperature is indicative of increased sympathetic drive and/or exercise stress due to vasoconstriction in the subcutaneous vascular bed. An adjunct to monitoring skin temperature to determine sympathetic drive is to monitor subcutaneous tissue impedance. Subcutaneous tissue impedance putatively increases during vasoconstriction. Thus, in accordance with the teachings herein, a sensed change in tissue impedance may be used by itself or as a compliment to compensate for confounding changes in environmental temperature.

Thus, in applications using EA stimulation for hypertension control, a sensed decrease in subcutaneous temperature and/or increase in subcutaneous impedance may be used to increase the duty cycle and/or intensity of chronic EA stimulation.

In a preferred embodiment, the temperature and impedance of the skin and/or nearby tissue is monitored by a sensor(s) incorporated within a subcutaneously placed chronic EA device. When the skin temperature decreases and/or subcutaneous tissue impedance increases, the EA output (where “output” means, e.g., the intensity and/or duty cycle of the applied stimuli) is increased in order to raise the level of sympathetic inhibition. For example, in response to detecting a vascular constriction event, the output of the EA device may be increased during the next 30 minute EA session of the stimulation regimen that is applied by the EA system.

### BRIEF DESCRIPTION OF THE DRAWINGS

The above and other aspects, features and advantages of the present invention will be more apparent from the following more particular description thereof, presented in conjunction with the accompanying drawings. These drawings illustrate various embodiments of the principles described herein and are a part of the specification. The illustrated embodiments are merely examples and do not limit the scope of the disclosure.

FIG. 1 is a block diagram that illustrates the two main components of a typical Electroacupunture (EA) Stimulation System made as taught in the patent application referenced in Paragraph [0002] above. Use of such EA Stimulation System (also referred to herein as an “EA System”) includes: (1) an External Control Device (ECD); and (2) an Implantable Stimulator (also referred to herein as a “Implantable Electroacupuncture Device” or IEAD). Two variations of the IEAD are depicted, either one of which could be used as part of the EA System, one having electrodes formed as an integral part of the IEAD housing, and another having the electrodes at or near the distal end of a very short lead that is attached to the IEAD.

FIG. 2A is an illustration of the human body, and shows the location of some acupoints that may be used in providing electroacupuncture treatment for a particular condition or disease of a patient.

FIG. 2B is an illustration of the human hand, showing with more particularity the location of acupoints PC5 and PC6.

FIG. 3A shows the use of one needle-type electrode integrated within the underneath side (the side farthest away from the skin) of a housing structure of an implantable electroacupuncture stimulator, or IEAS. This needle-type electrode is insulated from the other portions of the IEAS housing, which other portions of the housing structure may function as a return electrode for electroacupuncture stimulation.

FIG. 3A-1 is a sectional view, taken along the line 3A-3A of FIG. 3A, that shows one embodiment of the IEAS housing wherein the needle-type electrode resides in a cavity formed within the underneath side of the IEAS.

FIG. 3A-2 is a sectional view, taken along the line 3A-3A of FIG. 3A, and shows an alternative embodiment of the underneath side of the IEAS wherein the needle-type electrode comprises a bump that protrudes out from the underneath surface of the IEAS a short distance.

FIG. 3A-3 is a sectional view, taken along the line 3A-3A of FIG. 3A, and shows yet an additional alternative embodiment of the underneath side of the IEAS wherein the needle-type electrode is at or near the distal end of a short lead that extends out a short distance from the underneath side of, or an edge of, the IEAS.

FIG. 3B is similar to FIG. 3A, but shows the use of four needle electrodes integrated within the housing structure of an IEAS.

FIG. 3B-1 is a sectional view, taken along the line 3B-3B of FIG. 3B, that shows an embodiment where the needle electrodes comprise rounded bumps that protrude out from the underneath surface of the IEAS a very short distance.

FIG. 3B-2 is likewise a sectional view, taken along the line 3B-3B of FIG. 3B, that shows an alternative embodiment where the needle electrodes comprise tapering cones or inverted-pyramid shaped electrodes that protrude out from the underneath surface of the IEAS a short distance and end in a sharp tip.

FIG. 3B-3 is a also a sectional view, taken along the line 3B-3B of FIG. 3B, that shows yet another embodiment where the electrodes comprise small conductive pads formed at or near the distal end of a flex circuit cable (shown twisted 90 degrees in FIG. 3B-3) that extends out from the underneath surface of the IEAS a short distance.

FIGS. 3C-1 through 3C-5 show various alternate shapes of the housing of the IEAS that may be used with an EA System. Each respective figure, FIG. 3C-1, FIG. 3C-2, FIG. 3C-3, FIG. 3C-4 shows side sectional views of the housing shape, and FIG. 3C-5 includes a perspective view (labeled as “A”) and a side sectional view (labeled as “B”).

FIG. 4 is an electrical functional block diagram of the circuitry and electrical components housed within an EA System which includes an IEAS and External Controller in accordance with the various embodiments of the invention. The functional circuitry 30 shown to the right of FIG. 4 is what is typically housed within the IEAS. The functional circuitry 20 shown to the left of FIG. 4 is what is typically housed within the External Controller.

FIG. 5 shows a variation of the output circuitry that is used within the IEAS in order to implement closed loop feedback features that allow the IEAS to made adjustments, as needed, to integrate the operation of the EA stimulation regimen with the normal operation of the patient's autonomic nervous system (ANS) in such a way that the EA stimulation does not adversely affect the overall operation of the ANS.

FIG. 6 depicts, in graphical form, how monitored subcutaneous tissue impedance typically varies as a function of a patient's ANS sympathetic drive.

FIG. 7 depicts, in graphical form, how monitored skin temperature typically varies as a function of a patient's ANS sympathetic drive.

Throughout the drawings, identical reference numbers designate similar, but not necessarily identical, elements.

### DETAILED DESCRIPTION

Disclosed and claimed herein is a small electroacupuncture (EA) device. This EA device may also be referred to herein as a small neurostimulator device, an implantable electroacupuncture stimulator (IEAS), or similar names. The EA device has one or more electrode contacts within its housing or closely coupled to its housing. The EA device is adapted to be implanted through a very small incision, e.g., less than 2-3 cm in length, directly adjacent to a selected acupuncture site (or target nerve/tissue location) known to moderate or affect a patient=s physiological or health condition that needs treatment.

In accordance with the teachings herein, the small EA (or neurostimulator) device is implanted so that its electrodes are located and anchored at a target tissue stimulation site, which target site may also be referred to as an acupuncture site. (A target tissue stimulation site, or an acupuncture site, may also be referred to herein as an “acupoint.”) Stimulation pulses are applied by the EA device at the selected acupuncture site at a very low level and duty cycle in accordance with a specified stimulation regimen. This stimulation regimen is designed to provide effective electroacupuncture (EA) treatment for the physiological or health condition(s) of a patient that needs treatment.

Further, in accordance with the teachings herein, the small EA device includes means for monitoring at least one physiological parameter of the patient, which physiological parameter relates directly or indirectly to the operation of a patient's autonomic nervous system (ANS). In response to changes in the sensed physiological parameter, appropriate changes are made to the stimulation regimen applied by the small EA device in order to not adversely impact the normal operation or functioning of the patient's autonomic nervous system (ANS).

The monitored physiological parameter utilized by the EA device, system and/or methods described herein may include, e.g., (1) skin temperature or (2) subcutaneous tissue impedance, both of which relate to, or provide a measure of, a change in the patient's sympathetic drive. That is, a decrease in skin temperature is indicative of increased sympathetic drive and/or exercise stress due to vasoconstriction in the subcutaneous vascular bed. An adjunct to monitoring skin temperature to determine sympathetic drive is to monitor subcutaneous tissue impedance. Subcutaneous tissue impedance putatively increases during vasoconstriction. Thus, in accordance with the teachings herein, a sensed change in tissue impedance may be used by itself or as a compliment to compensate for confounding changes in environmental temperature.

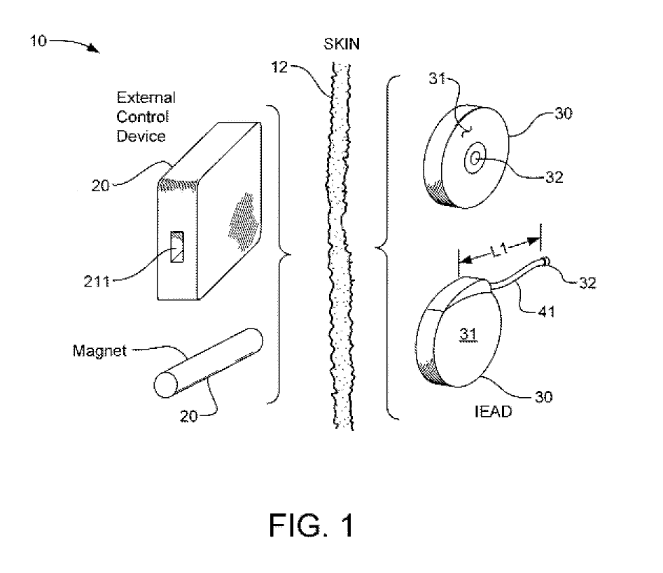

In the description that follows, it is noted that FIGS. 1, 2A, 2B, 3A, 3A-1, 3A-2, 3A-3, 3B, 3B-1, 3B-2, 3B-3, 3C-1, 3C-2 and 4, along with the textual description of such figures, are taken in substantial part from the patent applications referenced above in Paragraphs [0001] and [0002]. These referenced applications provide a description of an implantable EA device, system and/or method used to treat a particular disease or condition of the patient, e.g., hypertension. The present application describes an enhancement that may be made to the EA device(s), system(s) and/or method(s) described in the referenced applications. Before describing this enhancement in more detail, however, it will be helpful for the reader to first have a basic understanding of the EA device(s), system(s) and method(s) with which the enhancement is used.

Description of Basic EA Stimulation Device, System and/or Method

Turning first to FIG. 1, there is shown a perspective view of an exemplary EA System. The EA System has applicability to treating a variety of conditions, illnesses, disorders and deficiencies of a patient, and the present invention has applicability to all such applications.

As seen in FIG. 1, the EA System 10 includes two main components: (1) an External Control Device (ECD) 20 and (2) an Implantable ElectroAcupuncture Device 30, or IEAD 30. Two versions of the ECD 20 are included in FIG. 18. A first is a hand-held electronic device that includes a port 211 enabling it to be coupled to a computer, or similar processor. A second is a magnet, typically a cylindrical magnet.

Two versions of an IEAD are also included in FIG. 18, either one of which may be used. One embodiment (top right of FIG. 1) has an electrode 32 that forms an integral part of the case 31 of the IEAD 30; and the other embodiment (lower right of FIG. 1) has an electrode 32 that is located at the end of a short lead 41 attached to the IEAD 30.

The IEAD 30, in one embodiment, is disc shaped, having a diameter of about 2 to 3 cm, and a thickness of about 2 to 4 mm. It is implanted just under the skin 12 of a patient near a desired acupuncture site. Other shapes and sizes for the IEAD 30 may also be used, as described in more detail below. The desired acupuncture site is also referred to herein as a desired or target “acupoint.”

The IEAD 30 includes an electrode 32 which may take various forms. At least a portion of the electrode, in some embodiments, may include a rod-like body and a pointed or tapered tip, thereby resembling a needle. Because of this needle-like shape, and because the electrode 32 replaces the needle used during conventional acupuncture therapy, the electrode 32 may also be referred to as a “needle electrode”. However, an alternate and preferred electrode form to replace a “needle electrode” is a smooth surface electrode, without any sharp or pointed edges.

For the embodiment shown in the top right portion of FIG. 1, and for the IEAD 30, the electrode 32 forms an integral part of the housing 31 of the IEAD 30, and is located on a “front” side of the IEAD housing approximately in the center of the housing. As used here, “front” means the side of the housing that fronts or faces the tissue to be stimulated. Frequently, but not always, the front side is the side of the IEAD housing 31 farthest from the skin layer 12, or deepest in the body tissue. Other embodiments may incorporate an electrode that is not centered in the housing 31, and that is not even on the front side of the housing, but is rather on an edge of the housing 31.

Alternatively, as shown in the bottom right of FIG. 1, the electrode 32 may be located at the distal end of a short lead 41, e.g., nominally 10-20 mm long, but in some instances it may be up to 50 mm long, implanted with a strain relief loop to isolate movement of the case from the electrode. The proximal end of the lead, which may also be referred to herein as a “pigtail lead”, is attached to the IEAD 30 along an edge of the IEAD housing 31 or at a suitable connection point located on a side of the IEAD 30.

When implanted, the IEAD 30 is positioned such that the electrode 32 resides near, directly over, or otherwise faces the target tissue location, e.g., the desired acupoint or nerve, that is to be stimulated. For those embodiments where the electrode 32 forms an integral part of the housing 31 of the IEAD 30, there is thus no need for a long lead that must be tunneled through body tissue or blood vessels in order to place the electrode at the desired acupoint or nerve. Moreover, even for those embodiments where a very short lead may be employed between the IEAD 30 and the electrode 32, the tunneling required, if any, is orders of magnitude less than the present state of the art. In fact, with an electrode lead of between 20 mm and 50 mm in length, it is probable that no tunneling will be required. Further, because the electrode either forms an integral part of the IEAD housing 31, or is attached to the IEAD housing a very short pigtail lead, the entire IEAD housing 31 serves as an anchor to hold or secure the electrode 32 in its desired location.

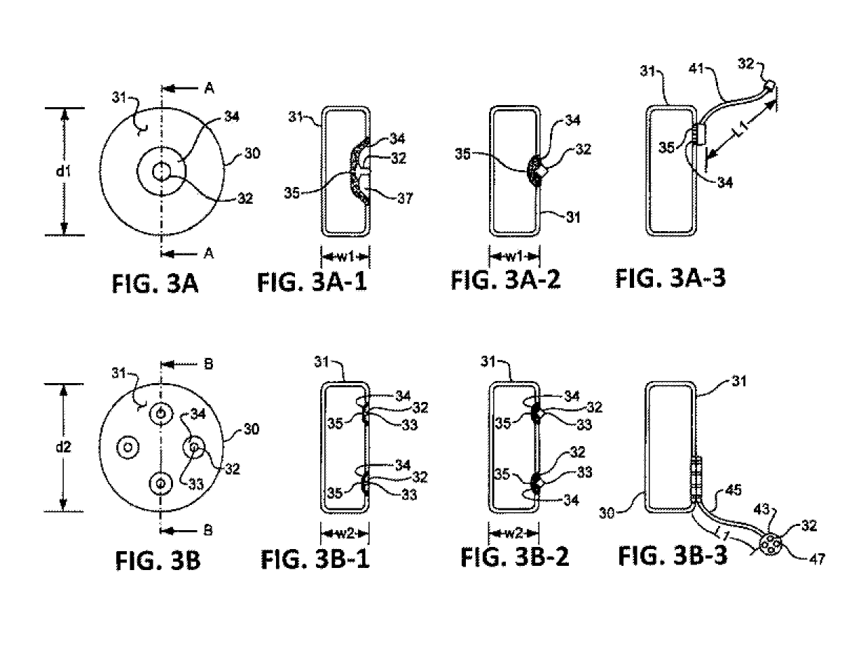

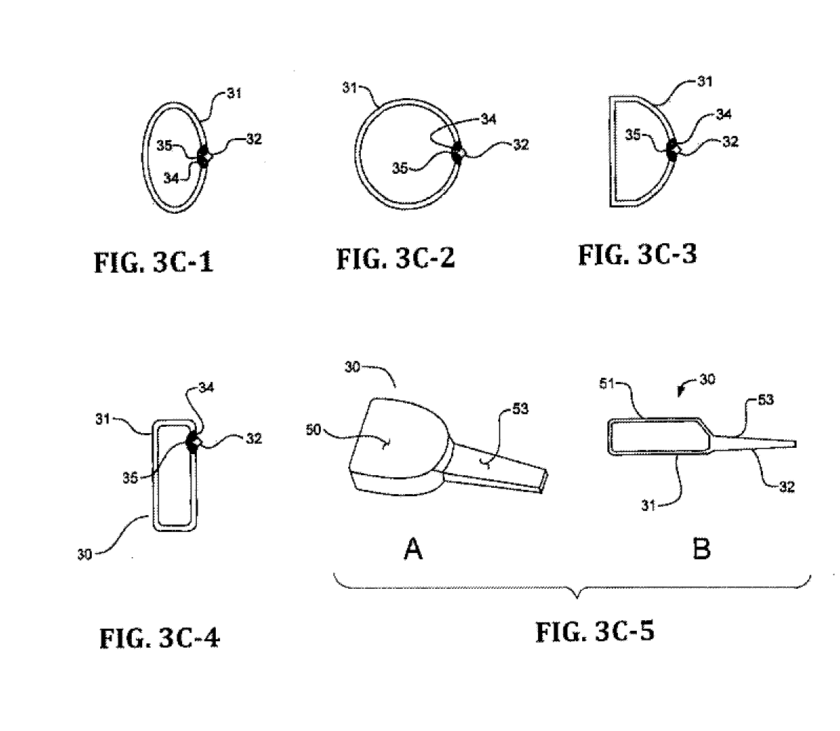

For the embodiment depicted in the top right of FIG. 1 and as mentioned above, the electrode 32 is located in the center of the front side of the IEAD 30. As explained in more detail below, this positioning of the electrode 32 is only exemplary, as various types of electrodes may be employed, as well as various numbers of electrodes and relative positioning. See, e.g., FIGS. 3A through 3C-5, and accompanying text, presented below.

Still referring to FIG. 1, the EA System 10 also includes an external control unit, or ECD, 20. A USB port 211, located on one side of the ECD, allows it to be connected to a PC or notebook computer or other suitable processor for diagnostic, testing, or programming purposes. Other ports or connectors may also be used on the ECD 20, as needed. In its simplest form, however, the ECD 20 may take the form of a handheld magnet.

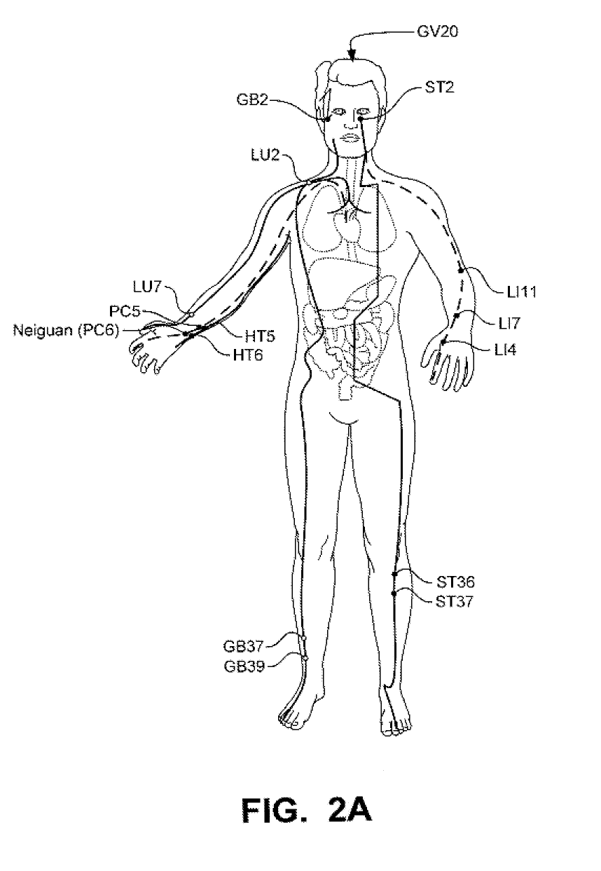

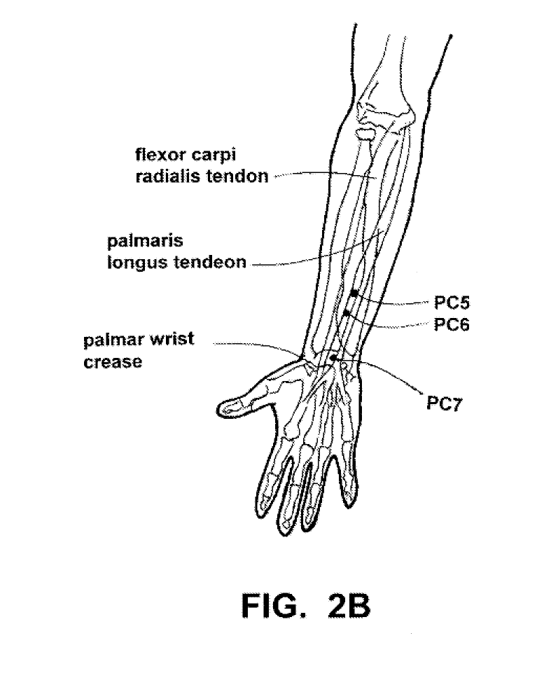

FIG. 2A shows an illustration of the human body, and shows the location of some acupoints that may be used in electroacupuncture for the treatment of various conditions or diseases of a patient.

FIG. 2B is an illustration of the human hand, showing with more particularity the location of acupoints PC5 and PC6. Further details regarding the location of acupoints PC5 and PC6 may be found in “WHO Standard Acupuncture Point Locations 2008”, previously referenced.

Turning next to FIGS. 3A, 3A-1 and 3A-2, a mechanical drawing of one embodiment of the housing 31 of the implantable electroacupuncture stimulator 30 is illustrated, along with various types of electrodes that may be used therewith. In a first embodiment, as seen in FIG. 3A, the housing 31 of the IEAS 30 is preferably disc-shaped, having a diameter “d1” and width “w1”. The housing 31 is made from a suitable body-tissue-compatible metal, such as platinum or stainless steel, having a thickness of about 1/16 of an inch (16 gauge). An electrode 32 resides at the center of the underneath side of the housing 31. The underneath side of the housing 31 is the side facing out of the paper in FIG. 3A, and is the side that is farthest away from the surface of the skin when the stimulator device is implanted in a patient.

The electrode 32 is surrounded by a ceramic or glass section 34 that electrically insulates the electrode 32 from the rest of the housing 31. This ceramic or glass 34 is firmly bonded to the metal of the housing 31 to form an hermetic seal. Similarly, a proximal end 35 of the electrode 34, best seen in the sectional views of FIG. 3A-1 or 3A-2, passes through the ceramic or glass 34, also forming an hermetic seal. The resultant structure resembles a typical feed-through pin commonly used in many implantable medical devices, and allows electrical connection to occur between electrical circuitry housed within the hermetically-sealed housing and body tissue located outside of the hermetically-sealed housing.

In the embodiment of the housing 31 shown in FIGS. 3A, 3A-1 and 3A-2, the electrode 32 is formed to have a narrow tip, much like a needle. Hence, the electrode 32 is sometimes referred to as a needle electrode. A needle electrode of this type generally allows the electric fields associated with having a current flowing out of or into the needle tip to be more sharply focused, and thereby allows the resultant current flow through the body tissue to also be more sharply focused. This helps the electrical stimulation to be applied more precisely at the desired acupuncture point. Further, because most acupoints tend to exhibit a lower resistance than do non-acupoints, the amount of power required to direct a stimulation current through the acupoint is lower, thereby helping to conserve power.

As is known in the art, all electrical stimulation requires at least two electrodes, one for directing, or sourcing, the stimulating current into body tissue, and one for receiving the current back into the electronic circuitry. The electrode that receives the current back into the electronic circuit is often referred to as a “return” or “ground” electrode. The metal housing 31 of the IEAS 30 may function as a return electrode during operation of the IEAS 30.

FIG. 3A-1 is a sectional view, taken along the line 3A-3A of FIG. 3A, that shows one embodiment of the IEAS housing wherein the needle-type electrode resides in a cavity formed within the underneath side of the IEAS housing 31.

FIG. 3A-2 is a sectional view, taken along the line 3A-3A of FIG. 3A, and shows an alternative embodiment of the underneath side of the IEAS wherein the needle electrode 32 forms a bump that protrudes out from the underneath surface of the IEAS a short distance.

FIG. 3A-3 is a sectional view, taken along the line 3A-3A of FIG. 3A, and shows yet another alternative embodiment where a short lead 41, having a length L1, extends out from the housing 31. The electrode 32, which may be a ball electrode or an egg-shaped electrode, is located at a distal end of the lead 41. The length L1 of this short electrode is typically in the range of 10 to 20 mm. A proximal end of the lead 41 attaches to the housing 31 of the IEAS 30 through a feed-through type structure made of metal 35 and glass (or ceramic) 34, as is known in the art.

Next, with reference to FIGS. 3B, 3B-1, 3B-2, and 3B-3 there is shown an embodiment of the IEAS 30 that shows the use of four electrodes integrated within the housing 31 of an IEAS 30. The electrodes 32 have a tip 33 that protrudes away from the surface of the housing 31 a short distance. A base, or proximal, portion of the electrodes 32 is embedded in surrounding glass or ceramic 34 so as to form an hermetic bond between the metal and ceramic. A proximal end 35 of the electrode 32 extends into the housing 31 so that electrical contact may be made therewith. The ceramic or glass 34 likewise forms a metallic bond with the edge of the housing 31, again forming an hermetic bond. Thus, the electrodes 32 and ceramic 34 and metal housing 31 function much the same as a feed-through pin in a conventional implantable medical device housing, as is known in the art. Such feed-through pin allows an electrical connection to be established between electrical circuitry housed within the hermetically-sealed housing 31 and body tissue on the outside of the hermetically sealed housing 31.

Having four electrodes arranged in a pattern as shown in FIG. 3B allows a wide variation of electric fields to be created emanating from the tip 33 of each needle electrode 32 based on the magnitude of the current or voltage applied to each electrode. That is, by controlling the magnitude of the current or voltage at each tip 32 of the four electrodes, the resulting electric field can be steered to a desired stimulation point, i.e., to the desired electroacupuncture (EA) point.

FIG. 3B-3 is a also a sectional view, taken along the line 3B-3B of FIG. 3B, that shows yet another embodiment of the EA device where the electrodes comprise small conductive pads 47 at or near the distal end of a flex circuit cable 45 that extends out from the underneath surface of the IEAS a very short distance. To facilitate a view of the distal end of the flex circuit cable 45, the cable is shown twisted 90 degrees as it leaves the underneath surface of the IEAS 30. When implanted, the flex circuit cable 45 may or may not be twisted, depending upon the relative positions of the IEAS 30 and the target acupoint to be stimulated. As can be seen in FIG. 3B-3, at the distal end of the flex circuit cable 45 the four electrodes 32 are arranged in a square pattern array. Other arrangements of the electrodes 32 may also be employed, a linear array, a “T” array, and the like.

While only one or four electrodes 32 is/are shown as being part of the housing 31 or at the end of a short lead or cable in FIGS. 3A and 3B, respectively, these numbers of electrodes are only exemplary. Any number of electrodes, e.g., from one to eight electrodes, that conveniently fit on the underneath side or edges of an IEAS housing 31, or on a paddle array (or other type of array) at the distal end of a short lead, may be used. The goal is to get at least one electrode (whether an actual electrode or a virtual electrode—created by combining the electric fields emanating from the tips of two or more physical electrodes) as close as possible to the target EA point, or acupoint. When this is done, the EA stimulation will usually be more effective.

Next, with reference to FIGS. 3C-1 through 3C-5, various alternate shapes of the housing 31 of the IEAS 30 that may be used with an EA System 10 are illustrated. The view provided in these figures is a side sectional view, with at least one electrode 32 also being shown in a side sectional view. In FIGS. 3C-1 through 3C-4, the electrode 32 is electrically insulated from the housing 31 by a glass or ceramic insulator 34. A portion of the electrode 32 passes through the insulator 34 so that a proximal end 35 of the electrode 32 is available inside of the housing 31 for electrical contact with electronic circuitry that is housed within the housing 31.

In FIG. 3C-1, the housing 31 is egg shaped (or oval shaped). A bump or needle type electrode 32 protrudes a small distance out from the surface of the housing 31. While FIG. 3C-1 shows this electrode located more or less in the middle of the surface of the egg-shaped housing, this positioning is only exemplary. The electrode may be located anywhere on the surface of the housing, including at the ends or tips of the housing (those locations having the smallest radius of curvature).

In FIG. 3C-2, the housing 31 of the IEAS 30 is spherical. Again, a bump or needle-type electrode 32 protrudes out a small distance from the surface of the housing 31 at a desired location on the surface of the spherical housing. The spherical housing is typically made by first making two semi-spherical housings, or shells, and then bonding the two semi-spherical housings together along a seam at the base of each semi-spherical shell. The electrode 32 may be located at some point along or near this seam.

In FIG. 3C-3, the housing 31 is semi-spherical, or dome shaped. A bump or needle electrode 32 protrudes out from the housing at a desired location, typically near an edge of the base of the semi-spherical or dome-shaped housing 31.

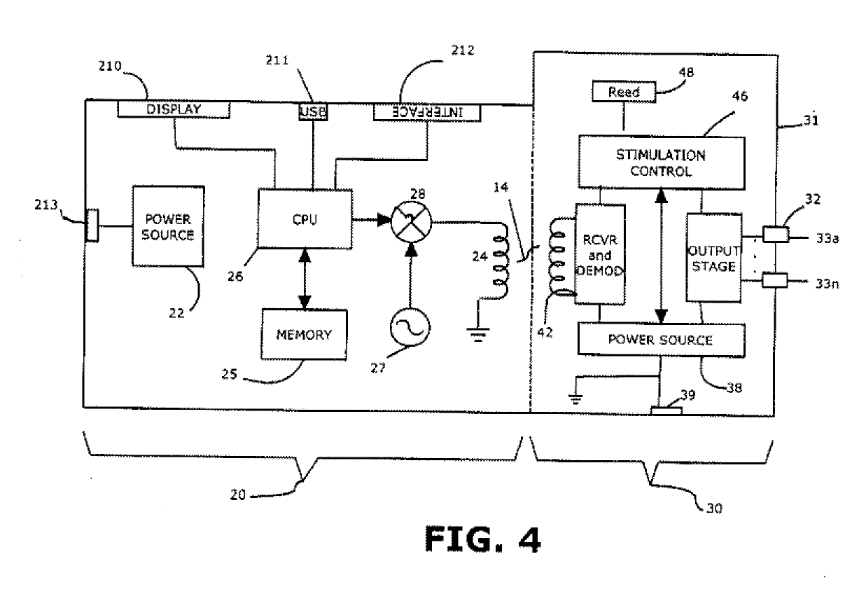

In FIG. 3C-4, the housing is rectangular in shape and has rounded edges and corners. A bump or needle electrode 32 protrudes out from the housing at a desired location on the underneath side of the housing, or along an edge of the housing. As shown in FIG. 3C-4, one location for positioning the electrode 32 is on the underneath side near the edge of the housing.

In FIG. 3C-5, the housing 31 is key shaped, having a base portion 51 and an arm portion 53. FIG. 3C-5 includes a perspective view “A” and a side sectional view “B” of the key-shaped housing 31. As shown, the electrode 32 may be positioned near the distal end of the arm portion 53 of the housing 31. The width of the arm portion 53 may be tapered, and all the corners of the housing 31 are rounded or slanted so as to avoid any sharp corners. The key-shaped housing shown in FIG. 3C-5, or variations thereof, is provided so as to facilitate implantation of the IEAS 32 through a small incision, starting by inserting the narrow tip of the arm portion 53, and then sliding the housing under the skin as required so that the electrode 32 ends up being positioned over, adjacent or on the desired acupoint.

In lieu of the bump or needle-type electrodes 32 illustrated in FIGS. 3C-1 through 3C-5, a smooth, flat or other non-protruding electrode 32 may also be used. One preferred electrode configuration is disclosed in U.S. Patent Application Ser. No. 61/606,995, filed 6 Mar. 2012, entitled “Electrode Configuration For Implantable Electroacupuncture Device, which patent application is incorporated herein by reference.

It is to be noted that while the various housing shapes depicted in FIGS. 3C-1 through 3C-5 have a bump or needle-type electrode (and which could also be a flat or smooth electrode as noted in the previous paragraph) that form an integral part of the IEAS housing 31, electrodes at the distal end of a short lead connected to the IEAS housing may also be employed with any of these housing shapes.

It is also to be emphasized that other housing shapes could be employed for the IEAS 30 other than those described. The invention described and claimed herein is not directed so much to a particular shape of the housing 31 of the IEAS 30, but rather to the fact that the IEAS 30 need not provide EA stimulation on a continuous basis, and therefore the power source carried in the IEAS need not be very large, which in turn allows the IEAS housing 31 to be very small. The resulting small IEAS 30 may then advantageously be implanted directly at or near the desired acupoint, without the need for tunneling a lead and an electrode(s) over a long distance, as is required using prior art implantable electroacupuncture devices. Instead, the small IEAS 30 used with the present invention applies its non-continuous EA stimulation regime at the desired acupoint without the use of long leads and extensive tunneling, which stimulation regime applies low intensity, low frequency and low duty cycle stimulation at the designated acupoint over a period of several months in order to favorably treat a condition, disease or deficiency of a patient.

Turning next to FIG. 4, an electrical functional block diagram of the electrical circuitry and electrical components housed within the IEAS 30 and the External Controller 20 is depicted. The functional circuitry shown to the right of FIG. 4 is what is typically housed within the IEAS 30. The functional circuitry shown to the left of FIG. 4 is what is typically housed within the External Controller 20.

It is to be noted and emphasized that the circuitry shown in FIG. 4, and in the other figures which show such circuitry, is intended to be functional in nature. In practice, a person of skill in the electrical, bioelectrical and electronic arts can readily fashion electronic circuits that will perform the intended functions. Such circuitry may be realized, e.g., using discrete components, application specific integrated circuits (ASIC), microprocessor chips, gate arrays, or the like.

As seen in FIG. 4, the components used and electrical functions performed within the IEAS 30 include, e.g., a power source 38, an output stage 40, an antenna coil 42, a receiver/demodulator circuit 44, a stimulation control circuit 46, and a reed switch 48. The components used and electrical functions performed with the External Controller 20 include, e.g., a power source 22, a transmission coil 24, a central processing unit (CPU) 26, a memory circuit 25, a modulator circuit 28 and an oscillator circuit 27. The External Controller 20 also typically employs some type of display device 210 to display to a user the status or state of the External Controller 20. Further, an interface element 212 may be provided that allows, e.g., a means for manual interface with the Controller 210 to allow a user to program parameters, perform diagnostic tests, and the like. Typically, the user interface 212 may include keys, buttons, switches or other means for allowing the user to make and select operating parameters associated with use of the EA System 10. Additionally, a USB port 211 is provided so that the External Controller 20 may interface with another computer, e.g., a laptop or notebook computer. Also, a charging port 213 (which may also be in the form of a USB port) allows the power source 22 within the External Controller 20 to be recharged or replenished, as needed.

In operation, the Stimulation Control Circuit 46 within the IEAS 30 has operating parameters stored therein that, in combination with appropriate logic and processing circuits, cause stimulation pulses to be generated by the Output Stage 40 that are applied to at least one of the electrodes 32, in accordance with a programmed or selected stimulation regime. The operating parameters associated with such stimulation regime include, e.g., stimulation pulse amplitude, width, and frequency. Additionally, stimulation parameters may be programmed or selected that define the duration of a stimulation session (e.g. 15, 30, 45 or 60 minutes), the frequency of the stimulation sessions (e.g., daily, twice a day, three times a day, once every other day, etc.) and the number of continuous weeks a stimulation session is applied, followed by the number of continuous weeks a stimulation session is not applied.

The Power Source 38 within the IEAS 30 may comprise a primary battery, a rechargeable battery, a supercapacitor, or combinations or equivalents thereof. For example, one embodiment of the power Source 38, as discussed below in connection with FIG. 7, may comprise a combination of a rechargeable battery and a supercapacitor.

The antenna coil 42 within the IEAS 30, when used (i.e., when the IEAS 30 is coupled to the External Controller 20 through a suitable communication link 14), receives an ac power signal (or carrier signal) from the External Controller 20 that may be modulated with control data. The modulated power signal is received and demodulated by the receiver/demodulator circuit 44. (The receiver/demodulator circuit 44 in combination with the antenna coil 42 may collectively be referred to as a receiver, or “RCVR”.) Typically the receiver/demodulator circuit 44 includes simple diode rectification and envelope detection, as is known in the art. The control data, obtained by demodulating the incoming modulated power signal is sent to the Stimulation Control circuit 46 where it is used to define the operating parameters and generate the control signals needed to allow the Output Stage 40 to generate the desired stimulation pulses.

It should be noted that the use of coils 24 and 42 to couple the external controller 20 to the IEAS 30 through, e.g., inductive or RF coupling, of a carrier signal is not the only way the external controller and IEAS may be coupled together, when coupling is needed (e.g., during programming and/or recharging). Optical coupling may also be employed.

The control data, when present, may be formatted in any suitable manner known in the art. Typically, the data is formatted in one or more control words, where each control word includes a prescribed number of bits of information, e.g., 4 bits, 8 bits, or 16 bits. Some of these bits may comprise start bits, other bits may comprise error correction bits, other bits may comprise data bits, and still other bits may comprise stop bits.

Power contained within the modulated power signal is used to recharge or replenish the Power Source 38 within the IEAS 30. A return electrode 39 is connected to a ground (GRD), or reference, potential within the IEAS 30. This reference potential may also be connected to the housing 31 (which housing is sometimes referred to herein as the “case”) of the IEAS 30.

A reed switch 48 may be employed within the IEAS 20 in some embodiments to provide a means for the patient, or other medical personnel, to use a magnet placed on the surface of the skin 12 of the patient above the area where the IEAS 30 is implanted in order to signal the IEAS that certain functions are to be enabled or disabled. For example, applying the magnet twice within a 2 second window of time could be used as a switch to manually turn the IEAS 300N or OFF.

The Stimulation Control Circuit 46 used within the IEAS 30 contains the appropriate data processing circuitry to enable the Control Circuit 46 to generate the desired stimulation pulses. More particularly, the Control Circuit 46 generates the control signals needed that will, when applied to the Output Stage circuit 40, direct the Output Stage circuit 40 to generate the low intensity, low frequency and low duty cycle stimulation pulses used by the IEAS 30 as it follows the selected stimulation regime. These stimulation pulses are applied to one or more of the needle (or other type) electrodes 33a . . . 33n, which electrodes may take many forms (as described, e.g., in FIGS. 3A and 3B, and accompanying sectional views).

The Control circuit 46 may comprise a simple state machine realized using logic gates formed in an ASIC. In other embodiments, it may comprise a more sophisticated processing circuit realized, e.g., using a microprocessor circuit chip.

In the External Controller 20, the Power Source 22 provides operating power for operation of the External Controller 20. This operating power also includes the power that is transferred to the power source 38 of the IEAS 30 whenever the implanted power source 38 needs to be replenished or recharged.

Because the External Controller 20 is an external device, the power source 22 may simply comprise a replaceable battery. Alternatively, it can comprise a rechargeable battery.

The External Controller 20 generates a power (or carrier) signal that is coupled to the IEAS 30 when needed. This power signal is typically an RF power signal (an AC signal having a high frequency, such as 40-80 MHz). An oscillator 27 is provided within the External Controller 20 to provide a basic clock signal for operation of the circuits within the External Controller 20, as well as to provide, either directly or after dividing down the frequency, the AC signal for the power or carrier signal.

The power signal is modulated by data in the modulator circuit 28. Any suitable modulation scheme may be used, e.g., amplitude modulation, frequency modulation, or other modulation schemes known in the art. The modulated power signal is then applied to the transmitting antenna or coil 24. The external coil 24 couples the power-modulated signal to the implanted coil 42, where the power portion of the signal is used to replenish or recharge the implanted power source 38 and the data portion of the signal is used by the Stimulation Control circuit 46 to define the control parameters that define the stimulation regime.

The memory circuit 25 within the External Controller 20 stores needed parameter data and other program data associated with the available stimulation regimes that may be selected by the user. In some embodiments, only a limited number of stimulation regimes are made available for the patient to use. Other embodiments may allow the user or other medical personnel to define one or more stimulation regimes that is/are tailored to a specific patient.

Description of Closed Loop EA Device, System and/or Method

As indicated previously, one technique for determining when an increase in sympathetic drive is needed is to monitor the body temperature at the skin. A decrease in skin temperature is indicative of increased sympathetic drive and/or exercise stress due to vasoconstriction in the subcutaneous vascular bed. An adjunct to monitoring skin temperature is to monitor subcutaneous tissue impedance. Subcutaneous tissue impedance putatively increases during vasoconstriction. Thus, in accordance with the teachings herein, a sensed change in tissue impedance may be used by itself or as a compliment to compensate for confounding changes in environmental temperature.

Thus, in applications using closed loop EA stimulation for, in this example, hypertension control, a sensed decrease in subcutaneous temperature and/or a sensed increase in subcutaneous impedance is used to increase the duty cycle and/or intensity of chronic EA stimulation. Similarly, a sensed increase in subcutaneous temperature and/or a sensed decrease in subcutaneous impedance is used to decrease the duty cycle and/or intensity of chronic EA stimulation.

Hence, in accordance with one preferred embodiment, an Implantable Electroacupuncture Stimulation (IEAS) device monitors changes in both the temperature and impedance of the skin and/or nearby tissue using sensors incorporated within a subcutaneously placed IEAS device. When the skin temperature decreases and/or impedance increases, the EA output (where “output” as used in this context means, e.g., the intensity and/or duty cycle of the applied stimulus signal) is increased in order to raise the level of sympathetic inhibition. For example, in response to detecting a vascular constriction event, the output of the EA device may be increased during the next EA session of the stimulation regimen that is applied by the EA system.

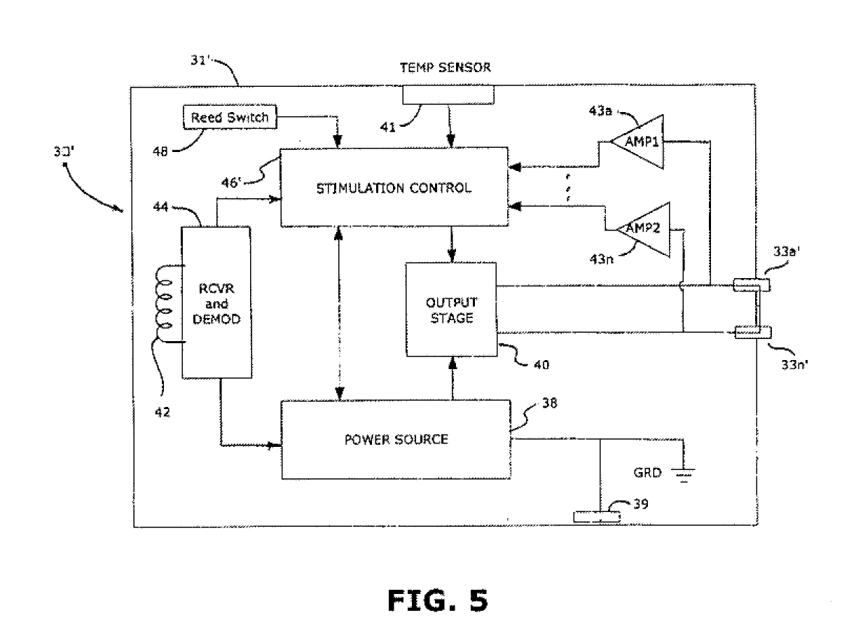

FIG. 5 shows a variation or enhancement of the circuitry used within an IEAS 30′ in order to implement closed loop feedback features that allow the IEAS 30′ to make adjustments, as needed, to integrate the operation of the EA stimulation regimen with the desired operation of the patient's autonomic nervous system (ANS). Such feedback controls the operation of the IEAS 30′ so that the EA stimulation does not adversely affect the overall operation of the patient's ANS.

As seen in FIG. 5, the enhanced IEAS 30′ contains the same elements as the previously described IEAS 30 (see FIG. 4) but with some new elements added. The same elements include a power source 38, a receiver and demodulation circuit 44, an antenna coil 42, a reed switch 48 and an output stage 40, all of which are the same as, or very similar to, the equivalent elements described above in connection with the description of FIG. 4. Also, the IEAS 30′ further includes needle (or other type) electrodes 33a′ . . . 33n′, the same as, or similar to, the feed-through pins or electrodes 31a . . . 31n included in the IEAS 30.

For the particular embodiment of the IIEAS 30′ depicted in FIG. 5, the new elements added to the enhanced IEAS 30′ include amplifier/buffer circuits 43a . . . 43n, coupled to respective needle electrodes 33a′ . . . 33n′, and a temperature sensor 41. The temperature sensor 41 is mounted to the inside surface of the housing 31 so as to sense the tissue temperature at a location just outside of the housing 31.

The amplifier/buffer circuits 43a . . . 43n have their outputs connected to an enhanced stimulation control circuit 46′. The temperature sensor 41 is also connected to the enhanced stimulation control circuit 46′. Thus, circuitry within the enhanced stimulation control circuit 46′ is able to receive and process signals representative of the tissue temperature sensed by the sensor 41, as well as the magnitude of any voltage and/or current signals appearing on the needle electrodes 33a′ . . . 33n′. These voltage and/or current signals, in turn, provide a way for the processing circuits within the stimulation control circuit 46′ to determine the tissue impedance, using, e.g., ohm's law, Ip=V/I, where Ip is the tissue impedance, V is the voltage across the tissue, and I is the current flowing through the tissue.

FIG. 7 depicts, in graphical form, how monitored skin temperature typically varies as a function of a patient's ANS sympathetic drive. Thus, by using a relationship such as that shown in FIG. 7, and by also knowing the tissue temperature, as sensed through the temperature sensor 41, it is possible to determine how much the sympathetic drive should be increased or decreased in order to compensate the performance of the patient's autonomic nervous system (ANS). An increase in sympathetic drive is accomplished by increasing the magnitude of the stimulation pulses, and or the duty cycle of the applied stimulation pulses, that are/is applied through the IEAS 30′ in accordance with the prescribed stimulation regimen. In other words, changes in sympathetic drive (whether an increase or a decrease) are realized by tweaking the stimulation regimen in an appropriate manner, e.g., by increasing/decreasing the magnitude of the stimulation pulses, increasing/decreasing the duty cycle at which a stimulation regimen is applied, or increasing/decreasing the frequency at which the stimulation pulses are applied within a stimulation session.

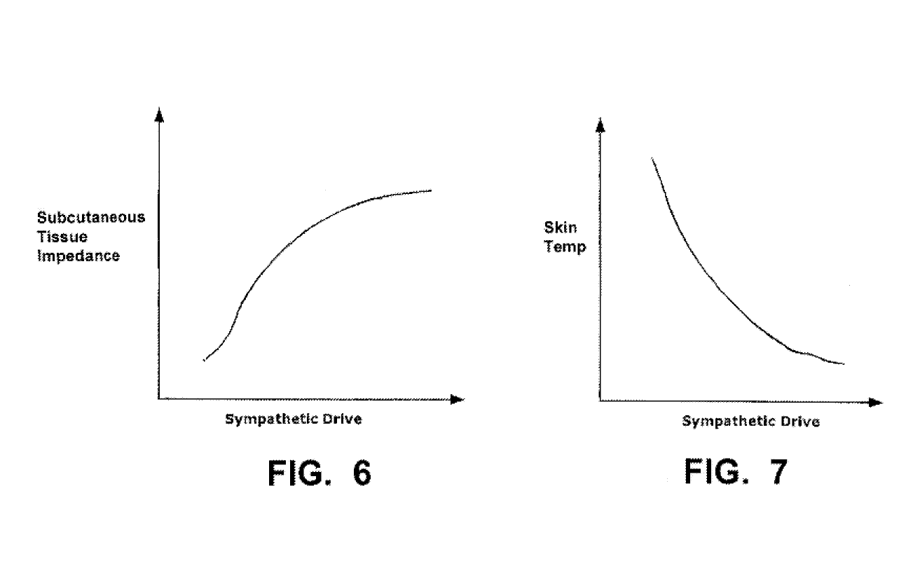

In order to verify that a change in skin temperature accurately portends a need to increase sympathetic drive, an additional measure may also be employed to monitor changes in subcutaneous tissue impedance. FIG. 6 depicts, in graphical form, how monitored subcutaneous tissue impedance typically varies as a function of a patient's ANS sympathetic drive. Thus, as shown in FIG. 6, as subcutaneous impedance increases, sympathetic drive also increases. As subcutaneous impedance decreases, sympathetic drive decreases.

The preceding description has been presented only to illustrate and describe embodiments of the invention. It is not intended to be exhaustive or to limit the invention to any precise form disclosed. Many modifications and variations are possible in light of the above teaching. Thus, while the invention(s) herein disclosed has been described by means of specific embodiments and applications thereof, numerous modifications and variations could be made thereto by those skilled in the art without departing from the scope of the invention(s) set forth in the claims

What is claimed is:

1. An implantable electroacupuncture (EA) device adapted to be implanted at a specified acupoint of a patient, the electroacupuncture device including:
a housing;
a pair of electrodes formed as an integral part of the housing;
stimulation circuitry residing inside the housing and electrically coupled to the pair of electrodes, wherein the stimulation circuitry generates stimulation pulses that are delivered to body tissue through the pair of electrodes in accordance with a prescribed stimulation regimen;
at least one sensor residing within the housing, the sensor including means for sensing at least one physiological parameter of the patient; and
feedback means responsive to changes in the sensed physiological parameter for modifying the stimulation regimen in a way that maintains functionality of the patient's autonomic nervous system (ANS).

2. The EA device of claim 1, wherein the at least one sensor comprises a temperature sensor that senses the temperature at or near the skin of the patient, and wherein the temperature sensed by the temperature sensor comprises the at least one physiological parameter used by the feedback means to modify the prescribed stimulation regimen.

3. The EA device of claim 2, further including a second sensor that includes means for measuring the impedance of the patient's subcutaneous tissue at or near the housing, and wherein the feedback means monitors the tissue impedance measured by the second sensor, as well as the skin temperature sensed by the temperature sensor, and in response to specified changes in the skin temperature and tissue impedance adjusts when and how the prescribed stimulation regimen is modified.

4. The EA device of claim 3, wherein the stimulation regimen is modified by the feedback means only if the temperature sensed by the temperature sensor over a prescribed time period and the impedance sensed by the impedance means over the prescribed time period both indicate a need to modify the patient's ANS in the same direction.

5. The EA device of claim 4, wherein the temperature sensed by the temperature sensor over the prescribed time period is weighted more than the impedance sensed by the second sensor over the prescribed time period in determining the magnitude of the adjustment made to the prescribed stimulation regimen.

6. The EA device of claim 4, wherein the temperature sensed by the temperature sensor over the prescribed time period is weighted less than the impedance sensed by the second sensor over the prescribed time period in determining the magnitude of the adjustment made to the prescribed stimulation regimen.

7. A method of operating an implantable electroacupuncture (EA) device, the EA device including a housing, at least two electrodes formed as an integral part of the housing, and stimulation circuitry residing within the housing coupled to the at least two electrodes, the method comprising:
implanting the EA device at a specified acupoint of a patient the wording in the doc submitted to the PTO, “implanting the EA device at a specified target tissue stimulation point that is near an acupoint of a patient;
controlling the EA device so that it generates stimulation pulses that are delivered through the at least two electrodes to the patient's body tissue at the specified acupoint in accordance with a specified stimulation regimen;
sensing a physiological condition of the patient that is related to the patient's autonomic nervous system (ANS); and
adjusting the stimulation regimen in response to changes that are sensed in the patient's physiological condition in a way that maintains functionality of the patient's ANS.

8. The method of claim 7, further including sensing a second physiological condition of the patient that is also related to the patient's ANS; and adjusting the stimulation regimen in response to changes that are sensed in both the first and second physiological conditions.

9. The method of claim 8, wherein adjusting the stimulation regimen comprises adjusting the stimulation regimen only when the changes sensed in both the first and second physiological conditions both indicate a need to increase the output delivered by the stimulation regimen.

10. The method of claim 9, further including increasing the output of the stimulation regimen by an amount determined by a weighted combination of the changes sensed in the first and second physiological parameters.

11. The method of claim 10, wherein the step of increasing the output of the stimulation regimen comprises weighting changes sensed in the first and second physiological parameters equally in order to determine how much the output of the stimulation regimen is to be increased.

12. The method of claim 10, wherein the step of increasing the output of the stimulation regimen comprises weighting changes sensed in the first physiological parameter more than changes in the second physiological parameter in order to determine how much the output of the stimulation regimen is to be increased

13. The method of claim 10, wherein the step of increasing the output of the stimulation regimen comprises weighting changes sensed in the first physiological parameter less than changes in the second physiological parameter in order to determine how much the output of the stimulation regimen is to be increased.

14. The method of claim 8, wherein adjusting the stimulation regimen comprises adjusting the stimulation regimen only when the changes sensed in both the first and second physiological conditions both indicate a need to decrease the output delivered by the stimulation regimen.

15. The method of claim 14, further including decreasing the output of the stimulation regimen by an amount determined by a weighted combination of the changes sensed in the first and second physiological parameters.

16. The method of claim 15, wherein the step of decreasing the output of the stimulation regimen comprises weighting changes sensed in the first and second physiological parameters equally in order to determine how much the output of the stimulation regimen is to be decreased.

17. The method of claim 15, wherein the step of decreasing the output of the stimulation regimen comprises weighting changes sensed in the first physiological parameter more than changes in the second physiological parameter in order to determine how much the output of the stimulation regimen is to be decreased.

18. The method of claim 15, wherein the step of decreasing the output of the stimulation regimen comprises weighting changes sensed in the first physiological parameter less than changes in the second physiological parameter in order to determine how much the output of the stimulation regimen is to be decreased.

19. The method of claim 8, wherein sensing the first physiological condition comprises sensing skin temperature at or near the location of the implanted EA device.

20. The method of claim 8, wherein sensing the second physiological condition comprises sensing subcutaneous tissue impedance at or near the location of the two electrodes of the implanted EA device.
